(19) United States
(12) Patent Application Publication
(10) Pub. No.: US 2009/0052155 A1
(43) Pub. Date: Feb. 26, 2009

(54) KEYPAD STRUCTURE WITH SURFACE ILLUMINATION

(75) Inventor: CHIEN-KUO TANG, TAIPEI COUNTY 231 (TW)

Correspondence Address: ROSENBERG, KLEIN & LEE, 3458 ELLICOTT CENTER DRIVE-SUITE 101, ELLICOTT CITY, MD, 21043, US

(73) Assignee: URC ELECTRONIC TECHNOLOGY (KUNSHAN) CO., LTD., JIANGSU (CN)

(21) Appl. No.: 11/845,397

(22) Filed: Aug. 27, 2007

(30) Foreign Application Priority Data
Aug. 22, 2007 (CN) 200710143040.1

(51) Int. Cl. H01H 9/00; G01D 11/28

(52) U.S. Cl. 362/30; 200/314

(57) ABSTRACT

The present invention relates to a keypad structure with surface illumination, which comprises a housing, a circuit board, a keypad set, and a plurality of light-emitting devices. The housing has an annular surface or a plurality of hoods. The circuit board is coupled electrically to the keypad set. The circuit board and the keypad set are adapted in the housing. The plurality of light-emitting devices is adapted in the housing and in the periphery of the keypad set. The light emitted by the plurality of light-emitting devices is reflected by the annular surface or the plurality of hoods, and by the sidewall of the housing, and is then projected to the surface of the keypad set.

### FIELD OF THE INVENTION

The present invention relates generally to a keypad structure, and particularly to a keypad structure with surface illumination.

### BACKGROUND OF THE INVENTION

With rapid progress of high technologies, market expansion of electronic products, and diversity in functions, the requirements by users in functions of electronic products as well as in quality of industrial design increase day by day. Modern people demand more and more strictly on appliances and digital and communication electronic products for daily uses. Thereby, modern electronic products pursue novelty, diversity, and quality continuously for satisfying present people's needs. For the electronic products used by current people, keypads are indispensable equipments. Without keypads, it is impossible to operate any electronic products that need keypads for applications.

In the current design of keypads, in order to make users be able to identify numbers, patterns, or functions on the keypads, most designs adopt a plurality of light-emitting diodes (LEDs) or fluorescent sheets on the back of the keypads. In addition, the keypads use transparent materials for making light penetrate from the back of the keypads to the front surface. Thereby, the users can identify numbers, patterns, or functions on the keypads in the dark.

In the Taiwan Patent number M244671 entitled “Light-Guiding Keypad for Mobile Phones”, a light-guiding keypad includes a plurality of transparent keypads attached on a soft securing sheet. In addition, a reflection layer made of a reflection material is adapted at the bottom of the transparent keypad, which has patterns for various numbers and functions. In the prior art, the keypad is illuminated by a light source on the side via reflection of the reflection layer. Owing to the reflection effect of light, the luminance on the transparent keypad is uniform.

The prior art described above makes users capable of identifying patterns, numbers, or functions marked on keypad of electronic products in the dark. However, the light is reflected from the bottom and penetrates from the back of the keypad to the front surface. Because the light needs to pass through the keypad as well as through other internal components, the power of the light is dissipated. Thereby, the illumination effect is poor today. Besides, if LEDs are used as the light source, a certain amount of the LEDs is required. Hence, costs will increase. Accordingly, the prior art cannot satisfy the practical needs of the users.

### SUMMARY

An objective if the present invention is to provide a keypad structure with surface illumination. According to the present invention, the light emitted by light-emitting devices does not need to penetrate other components but projects on the surface of the keypad set for achieving the effect of surface illumination. In addition, power loss of the light is reduced, and the illumination efficiency is increased. The amount of the light-emitting devices installed can be reduced as well. Hence, costs can be reduced accordingly.

Another objective of the present invention is to provide a keypad structure with surface illumination, which can be applied in an opaque keypad set for users to see clearly patterns yet on the keypad set.

The present invention provides a keypad structure with surface illumination, which comprises a housing, a circuit board, a keypad set, and a plurality of light-emitting devices. The housing extends to an annular reflection surface. The circuit board is adapted in the housing. The keypad set is adapted in the housing as well and is coupled electrically to the circuit board. The plurality of light-emitting devices is adapted in the housing and in the periphery of the keypad set, and is coupled electrically to the circuit board. The light emitted by the plurality of light-emitting devices is projected to the annular reflection surface or to the sidewall of the housing, and then is projected to the surface of the keypad set. Thus, users can see clearly the patterns marked on the keypad set. In addition, a reflection sheet can be further adapted to the annular reflection surface and the inner sidewall of the housing. A light uniformizer can also be further adapted to the annular reflection surface.

The present invention provides another keypad structure with surface illumination, which comprises a housing, a circuit board, a keypad set, a plurality of light-emitting devices. The housing has a plurality of hoods. The circuit board is adapted in the housing. The keypad set is coupled electrically to the circuit board. The plurality of light-emitting devices is adapted in the housing and in the periphery of the keypad set, and is coupled electrically to the circuit board. The light emitted by the plurality of light-emitting devices is projected to the hoods or to the sidewall of the housing, and then is projected to the surface of the keypad set via reflection. Thus, users can see clearly the patterns marked on the keypad set. In addition, a reflection sheet can be further adapted to the hoods and the inner sidewall of the housing, respectively. A light uniformizer can also be further adapted to the plurality of hoods.

### BRIEF DESCRIPTION OF THE DRAWINGS

FIG. 1 shows a three-dimensional view according to a preferred embodiment of the present invention;

FIG. 2 shows a cross-sectional view along AA′ of a keypad structure according to a preferred embodiment of the present invention;

FIG. 3 shows a cross-sectional view along AA′ of a keypad structure according to another preferred embodiment of the present invention;

FIG. 4 shows a cross-sectional view along AA′ of a keypad structure according to another preferred embodiment of the present invention;

FIG. 5 shows a three-dimensional view according to another preferred embodiment of the present invention;

FIG. 6 shows a cross-sectional view along AA′ of a keypad structure according to another preferred embodiment of the present invention;

FIG. 7 shows a cross-sectional view along AA′ of a keypad structure according to another preferred embodiment of the present invention;

FIG. 8 shows a cross-sectional view along AA′ of a keypad structure according to another preferred embodiment of the present invention; and

FIG. 9 shows a cross-sectional view along AA′ of a keypad structure according to another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

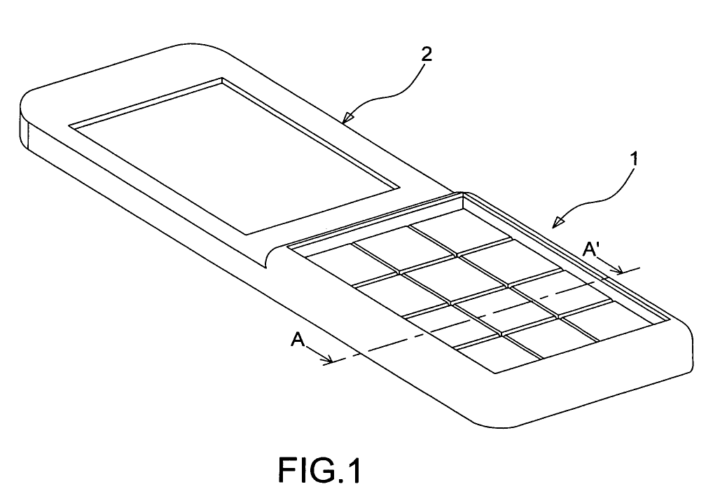

FIG. 1 shows a three-dimensional view according to a preferred embodiment of the present invention. As shown in the figure, the present invention provides a keypad structure 1 with surface illumination. The keypad structure 1 is applied in portable electronic devices, such as personal digital assistants (PDAs), mobile phones, multimedia players (MP3, MP4), and handheld game consoles. FIG. 1 illustrates the example when the keypad structure 1 according to the present invention is applied in a mobile phone 2.

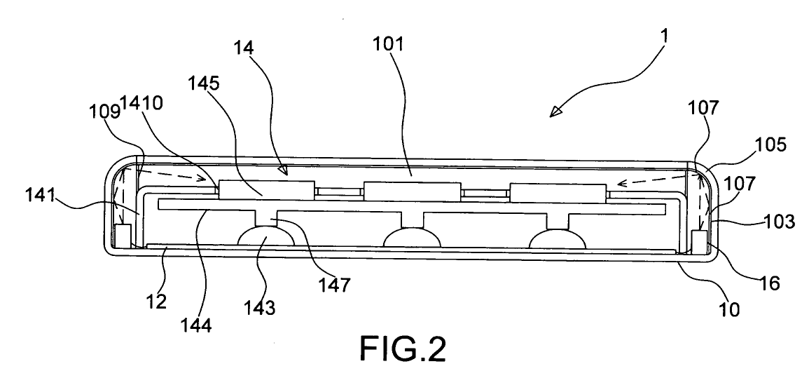

FIG. 2 shows a cross-sectional view along AA′ of a keypad structure according to a preferred embodiment of the present invention. As shown in the figure, the keypad structure 1 according to the present invention comprises a housing 10, a circuit board 12, a keypad set 14, and a plurality of light-emitting devices 16. The sidewall of the housing 10 extends to an annular reflection surface 105. The circuit board 12 is adapted at the bottom of the housing 10. The keypad set 14 is adapted in the housing 10 and is coupled electrically to the circuit board 12. The plurality of light-emitting devices 16 is adapted in the housing 19 and in the periphery of the keypad set 14. The plurality of light-emitting devices 16 of the keypad structure 1 according to the present preferred embodiment is adapted at the bottom of the housing 10, and is coupled electrically to the circuit board 12. In addition, the plurality of light-emitting devices can be a plurality of light-emitting diodes (LEDs).

The keypad set 14 includes a frame 141, a plurality of metallic leaf springs 143, and a touch layer 144. The frame 141 has a plurality of holes 1410. The plurality of metallic leaf springs 143 is coupled electrically to the circuit board 12. A plurality of salient keys 145 is adapted on the touch layer 144. The plurality of salient keys 145 corresponds to the plurality of metallic leaf springs 143, respectively, and is adapted in the plurality of holes 1410 correspondingly. Besides, a pattern layer (not shown in the figure) is adapted on each of the salient keys 145, respectively. The pattern layer has a plurality of patterns with each of the pattern corresponding to the function of the salient key 145. The touch layer 144 further has a plurality of pillars 147. Each of the plurality of pillars corresponds to a salient key 145 and a metallic leaf spring 143. The touch layer 144 is formed integrally with the plurality of pillars 147 with the material of the plurality of salient keys 145 being plastic.

A reflection sheet 107 is further adapted on the surface of the annular reflection surface 105 of the keypad structure 1 according to the present preferred embodiment facing the keypad set 14. In addition, a reflection sheet 107 is also adapted on the surface of the sidewall of the housing 10 facing the keypad set 14. Thereby, the light emitted by the plurality of light-emitting devices 16 is projected to the annular reflection surface 105 and to the sidewall 103 of the housing 10. The light, after reflected by the reflection sheets 107 adapted on the annular reflection surface 105 and the sidewall 103 of the housing 10, is then projected to the surface of the keypad set 14. Hence, light loss due to absorption is reduced. Moreover, the annular reflection surface 105 can further have a light uniformizer 109 to make the light be projected onto the surface of the keypad set 14 uniformly.

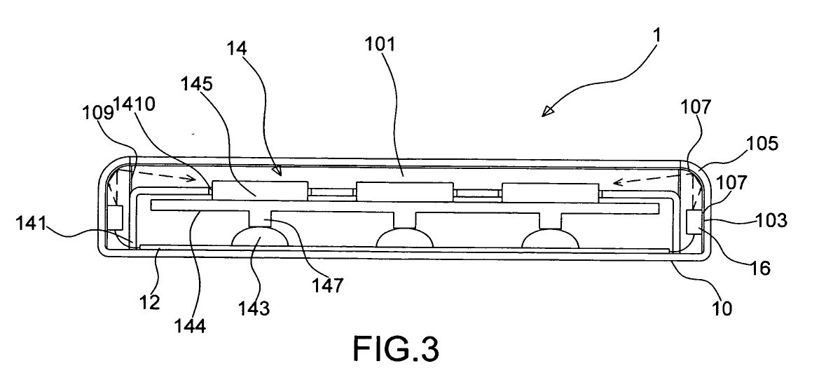

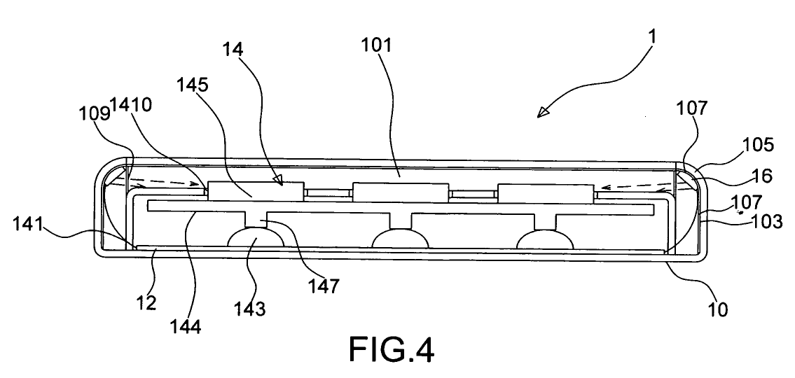

FIG. 3 shows a cross-sectional view along AA′ of a keypad structure according to another preferred embodiment of the present invention. As shown in the figure, the difference between the keypad structure 1 according to the present preferred embodiment and to the previous one is that the plurality of light-emitting devices 16 is adapted on the sidewall 103 of the housing 10. FIG. 4 shows a cross-sectional view along AA′ of a keypad structure according to another preferred embodiment of the present invention. As shown in the figure, the difference between the keypad structure 1 according to the present preferred embodiment and to the previous one is that the plurality of light-emitting devices 16 is adapted on the annular reflection surface 105.

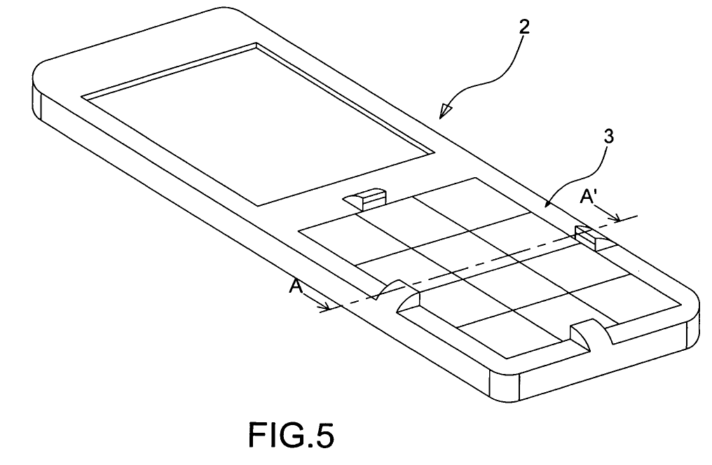

FIG. 5 shows a three-dimensional view according to another preferred embodiment of the present invention. As shown in the figure, the present invention provides a keypad structure 3 with surface illumination. FIG. 5 illustrates the example when the keypad structure 3 according to the present invention is applied in a mobile phone 2.

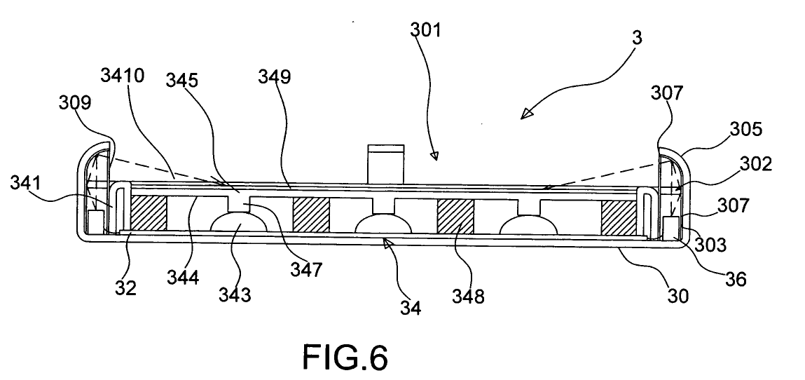

FIG. 6 shows a cross-sectional view along AA′ of a keypad structure according to another preferred embodiment of the present invention. As shown in the figure, the keypad structure 3 according to the present invention comprises a housing 30, a circuit board 32, a keypad set 34, and a plurality of light-emitting device 36. The housing 30 has a plurality of hoods 305. Each of which hoods corresponds to a gap 302, respectively. The plurality of gaps 302 is adapted on the housing 30. The circuit board 32 is adapted at the bottom of the housing 30. The keypad set 34 is coupled electrically to the circuit board 32. Besides, the plurality of light-emitting devices 36 is adapted in the housing 30, and in the periphery of the keypad set 34. The plurality of the light-emitting devices 36 of the keypad structure 30 according to the present preferred embodiment of the invention is adapted at the bottom of the housing 30, and is coupled electrically to the circuit board 32.

The keypad set 34 described above includes a frame 341, a plurality of metallic leaf springs 343, and a touch layer 344. The frame 341 ha an opening 3410. The plurality of metallic leaf springs 343 is coupled electrically to the circuit board 32. The touch layer 344 includes a plurality of planar keys 345, which corresponds to the plurality of metallic leaf springs 343, respectively, and is adapted in the opening 3410 correspondingly. In addition, a pattern layer 349 is adapted on the surfaces of the plurality of planar keys. The pattern layer 349 has a plurality of patterns, which corresponds to the plurality of planar keys 345, respectively. Beside, the touch layer 344 further has a plurality of pillars 347. Each of the pillars corresponds to a planar key 345 and a metallic leaf spring 343, respectively. The touch layer 344 is formed integrally with the plurality of pillars 347, and is secured on the circuit board 32 using glue 348. The material of the plurality of the planar keys 345 is plastic. The pattern layer 349 described above can further coat a layer of fluorescent ink for presenting another illumination effect.

A reflection sheet 307 is further adapted on the inner side of the hoods 305 of the keypad structure 3 according to the present preferred embodiment. Beside, a reflection sheet 307 is also adapted on the sidewall 303 of the housing 30 facing the keypad set 34. Hence, the light emitted by the plurality of light-emitting devices 36 is projected on the hoods and to the sidewall 303 of the housing 30. The light, after reflected by the reflection sheets 307 adapted on the hoods 305 and on the sidewall 303 of the housing 30, is then projected to the surface of the keypad set 34. Thereby, light loss due to absorption can be reduced, and the illumination efficiency is enhanced. In addition, the hoods 305 can further have a light uniformizer 309 to make the light be projected onto the surface of the keypad set 34 uniformly.

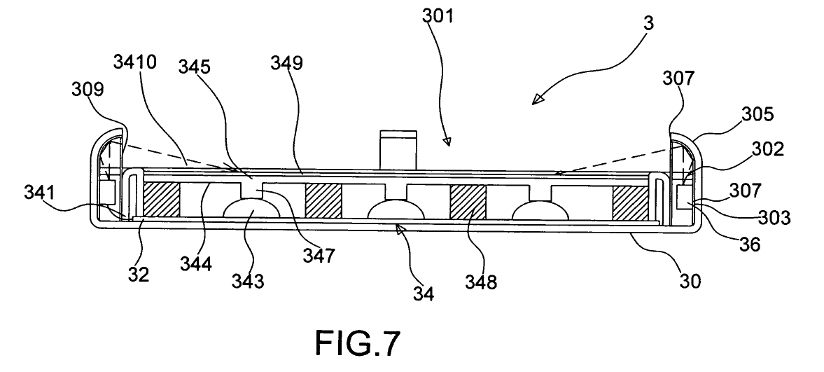

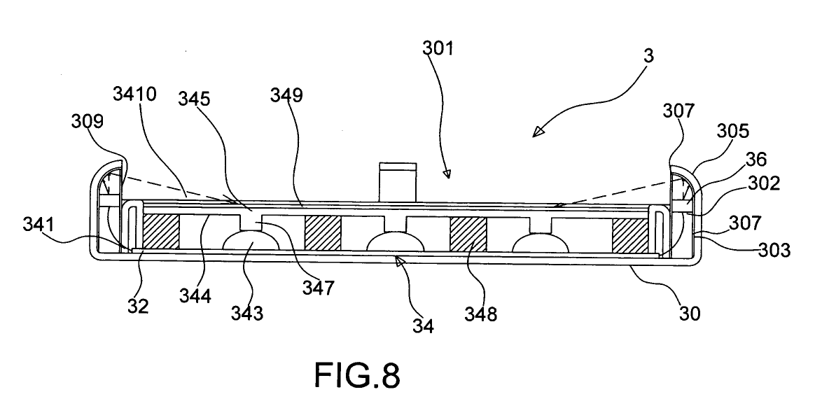

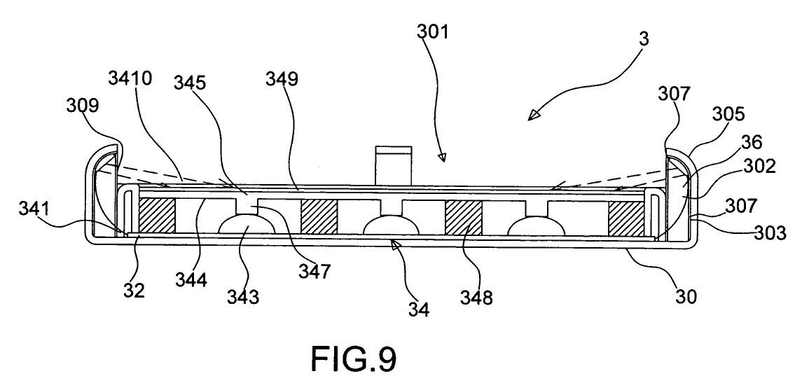

FIG. 7 shows a cross-sectional view along AA′ of a keypad structure according to another preferred embodiment of the present invention. As shown in the figure, the difference between the keypad structure 3 according to the present preferred embodiment and to the previous one is that the plurality of light-emitting devices 36 is adapted on the sidewall 303 of the housing 30. FIG. 8 shows a cross-sectional view along AA′ of a keypad structure according to another preferred embodiment of the present invention. As shown in the figure, the difference between the keypad structure 3 according to the present preferred embodiment and to the previous one is that the plurality of light-emitting devices 36 is adapted on the gap 302 of the housing 30. FIG. 9 shows a cross-sectional view along AA′ of a keypad structure according to another preferred embodiment of the present invention. As shown in the figure, the difference between the keypad structure 3 according to the present preferred embodiment and to the previous one is that the plurality of light-emitting devices 36 is adapted on inner sides of the hoods 305.

Moreover, the keypad sets 34 according to the preferred embodiments of FIGS. 6 to 9 can be replaced by the keypad set 14 according to the preferred embodiment of FIG. 2. Likewise, the keypad sets 14 according to the preferred embodiments of FIGS. 2 to 4 can be replaced by the keypad set 34 according to the preferred embodiment of FIG. 6.

To sum up, the present invention provides a keypad structure with surface illumination, in which a plurality of light-emitting devices adapted in the periphery of a keypad set emits light to project on an annular reflection surface or a hood. After reflected by the annular reflection surface or the hood, the light is projected on the surface of the keypad set, and hence users can see clearly the patterns on the keypad set. Thereby, in order to achieve the effect of surface illumination, the light of the keypad structure according to the present invention does not need to penetrate other components for projecting on the surface of the keypad set. In addition, loss in light power is reduced, and the illumination efficiency is enhanced. Besides, the amount of the light-emitting devices is reduced, decreasing the costs.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A keypad structure with surface illumination, comprising:
a housing, with sidewalls extending to an annular reflection surface;
a circuit board, adapted in the housing;
a keypad set, adapted in the housing and coupled electrically to the circuit board; and
a plurality of light-emitting devices, adapted in the housing and in the periphery of the keypad set, the light emitted by the plurality of light-emitting devices reflected by the annular reflection surface, and projected to the surface of the keypad set.

2. The keypad structure with surface illumination of claim 1, wherein a reflection sheet is adapted on the surface of the annular reflection surface facing the keypad set.

3. The keypad structure with surface illumination of claim 1, wherein a reflection sheet is adapted on the surface of the sidewall of the housing facing the keypad set.

4. The keypad structure with surface illumination of claim 1, wherein the annular reflection surface further has a light uniformizer.

5. The keypad structure with surface illumination of claim 1, wherein the light-emitting devices are light-emitting diodes.

6. The keypad structure with surface illumination of claim 1, wherein the plurality of light-emitting devices is coupled electrically to the circuit board.

7. The keypad structure with surface illumination of claim 1, wherein the keypad set comprises:
a frame, having a plurality of holes;
a plurality of metallic leaf springs, coupled electrically to the circuit board; and
a touch layer, comprising a plurality of salient keys which corresponds to the plurality of metallic leaf springs, respectively, and is adapted in the plurality of holes correspondingly.

8. The keypad structure with surface illumination of claim 7, wherein the keypad set further includes a plurality of pattern layers, adapted corresponding to the plurality of salient keys.

9. The keypad structure with surface illumination of claim 7, wherein the keypad set further includes a plurality of pillars, adapted on the touch layer, and corresponding to the plurality of salient keys and to the plurality of metallic leaf springs.

10. The keypad structure with surface illumination of claim 9, wherein the touch layer is formed integrally with the plurality of pillars.

11. The keypad structure with surface illumination of claim 1, wherein the keypad set comprises:
a frame, having an opening;
a plurality of metallic leaf springs, coupled electrically to the circuit board; and
a touch layer, comprising a plurality of planar keys which corresponds to the plurality of metallic leaf springs, respectively, and is adapted in the opening of the frame.

12. The keypad structure with surface illumination of claim 11, wherein the keypad set further comprises a pattern layer, having a plurality of patterns and corresponding to the plurality of planar keys, respectively.

13. The keypad structure with surface illumination of claim 11, wherein the keypad set further comprises a plurality of pillars, adapted on the touch layer, and corresponding to the plurality of planar keys and to the plurality of metallic leaf springs.

14. The keypad structure with surface illumination of claim 13, wherein the touch layer is formed integrally with the plurality of pillars.

15. The keypad structure with surface illumination of claim 11, wherein the touch layer uses glue to secure the circuit board.

16. A keypad structure with surface illumination, comprising:
a housing, having a plurality of hoods;
a circuit board, adapted in the housing;
a keypad set, adapted in the housing and coupled electrically to the circuit board; and
a plurality of light-emitting devices, adapted in the housing and in the periphery of the keypad set, corresponding to the plurality of hoods, respectively, and the light emitted by the plurality of light-emitting devices reflected by the corresponding plurality of hoods to the surface of the keypad set.

17. The keypad structure with surface illumination of claim 16, wherein the plurality of hoods corresponds to a gap, respectively, and the gap adapted in the housing.

18. The keypad structure with surface illumination of claim 16, wherein a reflection sheet is adapted on each inner side of the plurality of hoods.

19. The keypad structure with surface illumination of claim 16, wherein a reflection sheet is adapted on the surface of the sidewall of the housing facing the keypad set.

20. The keypad structure with surface illumination of claim 16, wherein the hood further has a light uniformizer.

21. The keypad structure with surface illumination of claim 16, wherein the light-emitting devices are light-emitting diodes.

22. The keypad structure with surface illumination of claim 16, wherein the plurality of light-emitting devices is coupled electrically to the circuit board.

23. The keypad structure with surface illumination of claim 16, wherein the keypad set comprises:
a frame, having a plurality of holes;
a plurality of metallic leaf springs, coupled electrically to the circuit board; and
a touch layer, comprising a plurality of salient keys which corresponds to the plurality of metallic leaf springs, respectively, and is adapted in the plurality of holes correspondingly.

24. The keypad structure with surface illumination of claim 23, wherein the keypad set further includes a plurality of pattern layers, adapted corresponding to the plurality of salient keys.

25. The keypad structure with surface illumination of claim 24, wherein the keypad set further includes a plurality of pillars, adapted on the touch layer, and corresponding to the plurality of salient keys and to the plurality of metallic leaf springs.

26. The keypad structure with surface illumination of claim 25, wherein the touch layer is formed integrally with the plurality of pillars.

27. The keypad structure with surface illumination of claim 16, wherein the keypad set comprises:
a frame, having an opening;
a plurality of metallic leaf springs, coupled electrically to the circuit board; and
a touch layer, comprising a plurality of planar keys which corresponds to the plurality of metallic leaf springs, respectively, and is adapted in the opening of the frame.

28. The keypad structure with surface illumination of claim 27, wherein the keypad set further comprises a pattern layer, having a plurality of patterns and corresponding to the plurality of planar keys, respectively.

29. The keypad structure with surface illumination of claim 27, wherein the keypad set further comprises a plurality of pillars, adapted on the touch layer, and corresponding to the plurality of planar keys and to the plurality of metallic leaf springs.

30. The keypad structure with surface illumination of claim 29, wherein the touch layer is formed integrally with the plurality of pillars.

31. The keypad structure with surface illumination of claim 27, wherein the touch layer uses glue to secure the circuit board.
